(19) United States
(12) Patent Application Publication
(10) Pub. No.: US 2025/0373177 A1
(43) Pub. Date: Dec. 4, 2025

(54) SOFT-SWITCHING INVERTER WITH A SYMMETRIC CURRENT SHARING

(71) Applicant: Huawei Digital Power Technologies Co., Ltd., Shenzhen (CN)

(72) Inventors: Daniel Gaona, Munich (DE); Eduardo Facanha De Oliveira, Munich (DE); Frank Heerdt, Nuremberg (DE); Chen Chen, Nuremberg (DE)

(73) Assignee: Huawei Digital Power Technologies Co., Ltd., Shenzhen (CN)

(21) Appl. No.: 19/297,194

(22) Filed: Aug. 12, 2025

Related U.S. Application Data
(63) Continuation of application No. PCT/EP2023/053523, filed on Feb. 13, 2023.

(51) Int. Cl. H02M 7/483; H02M 1/00

(52) U.S. Cl. CPC H02M 7/483; H02M 1/0058

(57) ABSTRACT

An inverter for generating an alternate current signal from a direct current signal is provided, including a positive voltage rail and a negative voltage rail. The inverter includes a switching unit, which, in turn, includes an alternating current output and a plurality of switches. Each of the plurality of switches includes a parasitic capacitance. The switching unit is configured to alternatingly switch the positive voltage of the direct current signal, a mid-point voltage between the positive voltage and the negative voltage of the direct current signal, and the negative voltage of the direct current signal to the alternating current output.

### CROSS-REFERENCE TO RELATED APPLICATIONS

This application is a continuation of International Application No. PCT/EP2023/053523, filed on Feb. 13, 2023, the disclosure of which is hereby incorporated by reference in its entirety.

### TECHNICAL FIELD

The embodiments relate to inverters for generating alternating current signals from direct current signals. The embodiments also relate to the soft-switching of such inverters.

### BACKGROUND

Three-level T-type, 3LTT, switching legs may be used in inverters for many applications, ranging from solar photo voltaic systems to automotive inverters. A 3LTT experiences conduction and switching losses which are detrimental to the efficiency of the system. The reduction of turn-on and turn-off losses with the minimum effort is desirable to increase efficiency with non/minimum penalizing the power density. Soft-switching strategies/topologies are a way to achieve this target.

Most soft-switching strategies rely on the use of auxiliary components that are active during the commutation. These components can increase the size and cost which in turn affects the efficiency and power density of the system. Thus, methods/topologies that can achieve soft-switching with minimum cost and size are highly appreciated.

To achieve soft-switching of the converter, resonant topologies are used which add a magnetic element to the commutation loop. This element resonates with the parasitic capacitor of the main switches. During the resonant transient, the voltage in the capacitor decays to zero; at this point, the switches can be turned on without losses, which is called zero-voltage-switching (ZVS).

Such resonant topologies are rather disadvantageous because they often require large components, incur high losses, and may generate voltage imbalances.

### SUMMARY

Accordingly, an objective of the embodiments is to provide an inverter which incurs only minimal switching losses.

These and other objectives are shown and described with respect to the embodiments.

According to a first aspect of the embodiments, an inverter for generating an alternate current signal from a direct current signal is provided. The inverter includes a positive voltage rail, which is configured to input a positive voltage of the direct current signal, and a negative voltage rail, configured to input a negative voltage of the direct current signal. Moreover, the inverter includes a switching unit, which in turn includes an alternating current output and a plurality of switches. Each of the plurality of switches includes a parasitic capacitance. The switching unit is configured to output the alternating current signal. The switching unit is, moreover, configured to alternatingly switch the positive voltage of the direct current signal, a mid-point voltage between the positive voltage and the negative voltage of the direct current signal, and the negative voltage of the direct current signal to the alternating current output. Moreover, the inverter includes an auxiliary circuit, which is configured to provide currents to the alternating current output to charge and discharge the parasitic capacitances of the switches before at least some switching operations of the switching unit. The auxiliary circuit therein includes an asymmetrical transformer, which includes a primary winding and a secondary winding. The primary winding and the secondary winding are magnetically coupled. The asymmetrical transformer is configured to generate the current required to charge and discharge the parasitic capacitances of the switches. This allows for a significant reduction in the switching losses, while at the same time requiring only small-scale components.

In an embodiment, the auxiliary circuit is configured to generate a commutation voltage so as to enable zero-voltage-switching (ZVS) of switches of the switching unit. This allows for a high reduction of the switching losses.

In an embodiment, the switching unit includes a first capacitor, connected between the positive voltage rail and a midpoint, and a second capacitor, connected between the negative voltage rail and the midpoint. Moreover, the switching unit then includes a first switching transistor, connected between the alternating current output and the positive voltage rail, configured to switch the alternating current output to the positive voltage. In this case, the switching unit includes either a bi-directional switch or a second switching transistor and a third switching transistor, connected in anti-series between the alternating current output and the midpoint, configured to switch the alternating current output to a midpoint voltage. Furthermore, in this case, the switching unit includes a fourth switching transistor, connected between the alternating current output and the negative voltage rail, configured to switch the alternating current output to the negative voltage. This allows for an effective inverter operation.

In an embodiment, the primary winding and the secondary winding are directly connected to the alternating current output. This leads to an efficient circuit topology.

Alternatively, in an embodiment, the primary winding is connected to the alternating current output through a first auxiliary inductor, which is, for example, a leakage inductance of the primary winding, and the secondary winding is connected to the alternating current output through a second auxiliary inductor, which is, for example, a leakage inductance of the secondary winding. This further improves the performance of the auxiliary circuit.

In an embodiment, the primary winding and the secondary winding are connected to the alternating current output through a third auxiliary inductor. This further improves the performance of the auxiliary circuit, for example, in case the leakage inductances are low.

In an embodiment, the auxiliary circuit includes a fifth switching transistor, connected between the positive voltage rail and the primary winding, a sixth switching transistor, connected between the negative voltage rail and the secondary winding, a seventh switching transistor, connected between the positive voltage rail and the secondary winding, and an eighth switching transistor, connected between the negative voltage rail and the primary winding. This allows for a simple construction of the auxiliary circuit.

In an embodiment, the primary winding has fewer turns than the secondary winding, for example, less than one-half of the turns of the secondary winding, or for example less than one-third of the turns of the secondary winding. Very efficient control of the commutation voltage is thereby achieved.

In an embodiment, the auxiliary circuit is configured to charge and/or discharge the parasitic capacitances of the switches before all switching operations of the switching unit. This achieves a reduction of switching losses for all operational states.

Alternatively, in an embodiment, the auxiliary circuit is configured to charge and/or discharge the parasitic capacitances of the switches only before switching operations of the switching unit, when the inverter is operating at a power level below its threshold value. The threshold value, for example, is within 30-90% of the maximum power of the inverter, or the threshold value may even be within 40-80% of the maximum power level of the inverter, or the threshold value may even be between 50-70% of the maximum power level of the inverter. By operating the auxiliary circuit only at reduced power levels of the inverter, the size of the components of the auxiliary circuit can be reduced, because it does not have to accommodate the maximum currents at high power levels of the inverter.

In an embodiment, the inverter includes a first diode bridge, and a series connection of a first diode and a second diode, connected between the positive voltage rail and a negative voltage rail, the first diode bridge including a mid-point between the first diode and the second diode. Moreover, in this case, the inverter includes a second diode bridge, including a series connection of a third diode and a fourth diode, connected between the positive voltage rail and a negative voltage rail. The second diode bridge also includes a mid-point between the third diode and the fourth diode. Moreover, in this case, the inverter includes a further coupled inductance, inductively coupled to the primary winding and the secondary winding of the transformer, operating as a third winding. The mid-points of the diode bridges are connected to each other through the further coupled inductance. This embodiment provides an alternative construction of the auxiliary circuit, which for some applications provides an improved topology.

In an embodiment, the further coupled inductance has as many turns as a sum of the turns of the primary winding and the secondary winding. This achieves an optimal setting of the commutation voltage.

In an embodiment, the inverter further includes a fourth auxiliary inductor, coupled between the alternating current output and a connection of the primary and the secondary windings. This allows for an efficient circuit design, for instance, in case of low leakage inductances.

According to a second aspect of the embodiments, an inverter system for generating a three-phase alternating current signal is provided. The inverter system includes a first inverter according to the first aspect, a second inverter according to the first aspect, and a third inverter according to the first aspect. The first inverter is configured to generate a first phase signal of the three-phase alternating current signal, the second inverter is configured to generate a second phase signal of the three-phase alternating current signal, and the third inverter is configured to generate a third phase signal of the three-phase alternating current signal. This allows for a simple construction of a three-phase inverter.

The first inverter, the second inverter, and the third inverter may respectively form a first inverter leg, a second inverter leg, and a third inverter leg of the inverter system. For example, the inverter system includes a joint positive voltage rail and a joint negative voltage rail. The positive voltage rails of the first inverter leg, the second inverter leg, and the third inverter leg are connected to the joint positive voltage rail. The negative voltage rails of the first inverter leg, the second inverter leg, and the third inverter leg are connected to the joint negative voltage rail. This allows for an efficient construction of the inverter system.

Generally, it should be noted that all arrangements, devices, elements, units, manners, and means described in the embodiments could be implemented by software or hardware elements or any kind of combination thereof. Furthermore, the devices may be processors or may include processors, where the functions of the elements, units, manners, and means described in the embodiments may be implemented in one or more processors. All steps which are performed by the various entities described in the embodiments, as well as the functionality described to be performed by the various entities, are intended to mean that the respective entity is adapted to or configured to perform the respective steps and functionalities. Even when, in the following description or specific embodiments, a specific functionality or step to be performed by a general entity is not reflected in the description of a specific detailed element of that entity that performs that specific step or functionality, it should be clear for a skilled person that these methods and functionalities can be implemented in respect of software or hardware elements, or any kind of combination thereof.

### BRIEF DESCRIPTION OF DRAWINGS

The embodiments are explained in detail in relation to the enclosed drawings, in which:

FIG. 1 shows a first embodiment of the inverter in a circuit diagram;

FIG. 2 shows a second embodiment of the inverter in a circuit diagram;

FIG. 3 shows an equivalent circuit diagram of an element of a third embodiment of the inverter;

FIG. 4a shows a first functional state of a fourth embodiment of the inverter;

FIG. 4b shows a second functional state of the fourth embodiment of the inverter;

FIG. 4c shows a third functional state of the fourth embodiment of the inverter;

FIG. 4d shows a fourth functional state of the fourth embodiment of the inverter;

FIG. 4c shows a fifth functional state of the fourth embodiment of the inverter;

FIG. 4f shows a sixth functional state of the fourth embodiment of the inverter;

FIG. 5a shows a number of currents in different operational states of a fifth embodiment of the inverter;

FIG. 5b shows a number of currents in consecutive functional states of the fifth embodiment of the inverter;

FIG. 5c shows a number of voltages in successive functional states of the fifth embodiment of the inverter;

FIG. 5d shows a number of voltages in successive operational states of the fifth embodiment of the inverter;

FIG. 6 shows an embodiment of the inverter system;

FIG. 7 shows a seventh embodiment of the inverter in a circuit diagram;

FIG. 8 shows an eighth embodiment of the inverter in a circuit diagram;

FIG. 9a shows a first functional state of a ninth embodiment of the inverter;

FIG. 9b shows a second functional state of the ninth embodiment of the inverter;

FIG. 9c shows a third functional state of the ninth embodiment of the inverter;

FIG. 9d shows a fourth functional state of the ninth embodiment of the inverter;

FIG. 10a shows a first functional state of a tenth embodiment of the inverter;

FIG. 10b shows a second functional state of the tenth embodiment of the inverter;

FIG. 10c shows a third functional state of the tenth embodiment of the inverter;

FIG. 10d shows a fourth functional state of the tenth embodiment of the inverter;

FIG. 11a shows a number of currents in successive functional states of an eleventh embodiment of the inverter;

FIG. 11b shows a number of currents in successive functional states of the eleventh embodiment of the inverter;

FIG. 11c shows a number of voltages in consecutive functional states of the eleventh embodiment of the inverter;

FIG. 11d shows a number of voltages in consecutive functional states of the eleventh embodiment of the inverter.

### DETAILED DESCRIPTION OF EMBODIMENTS

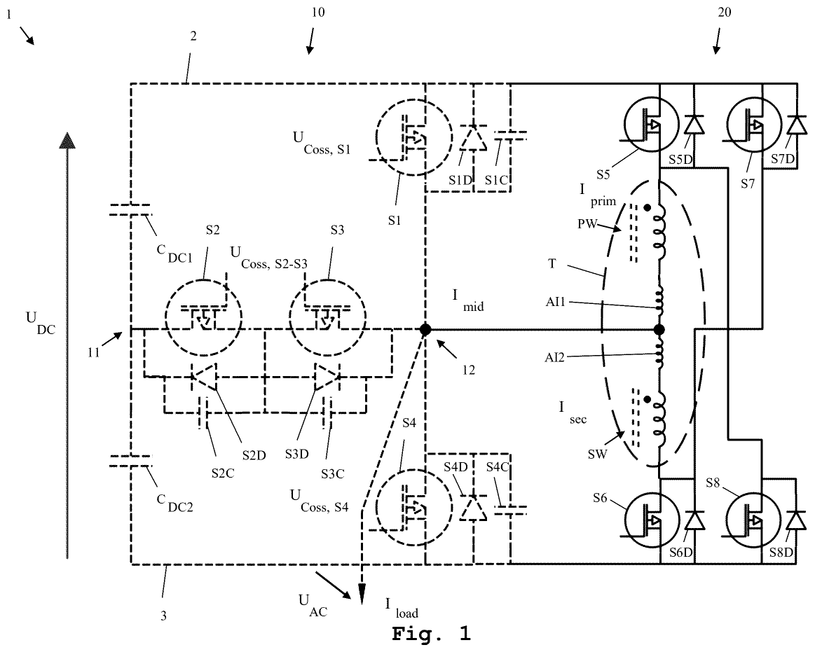

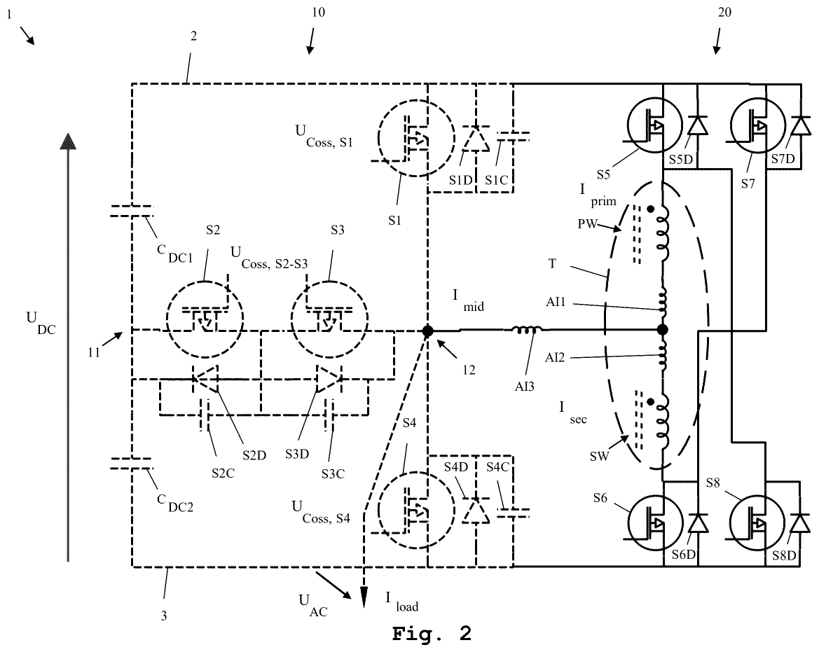

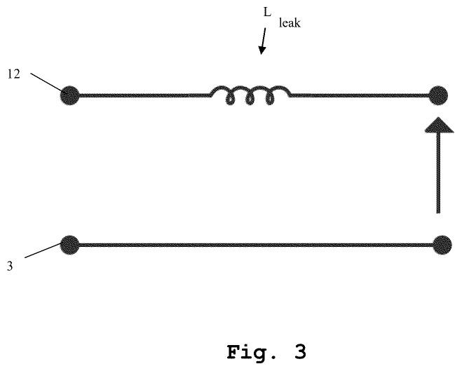

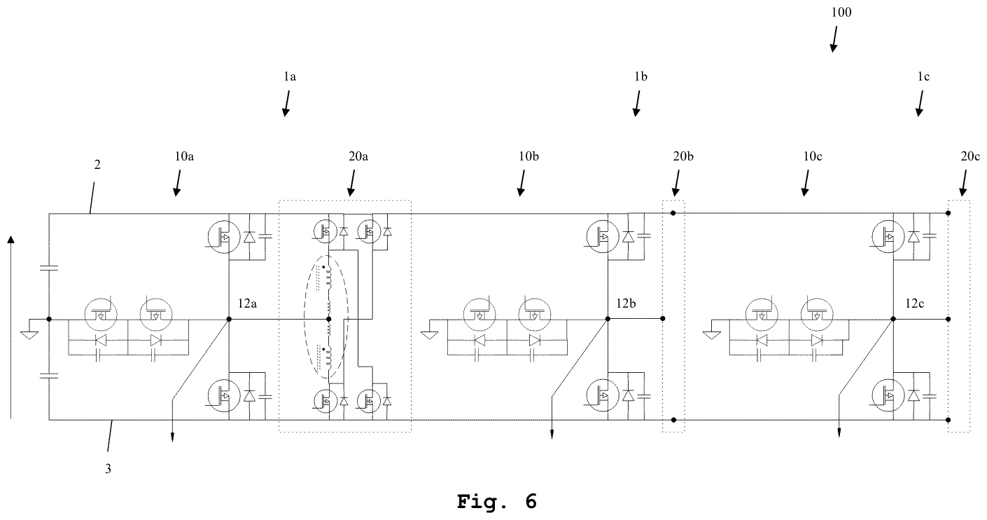

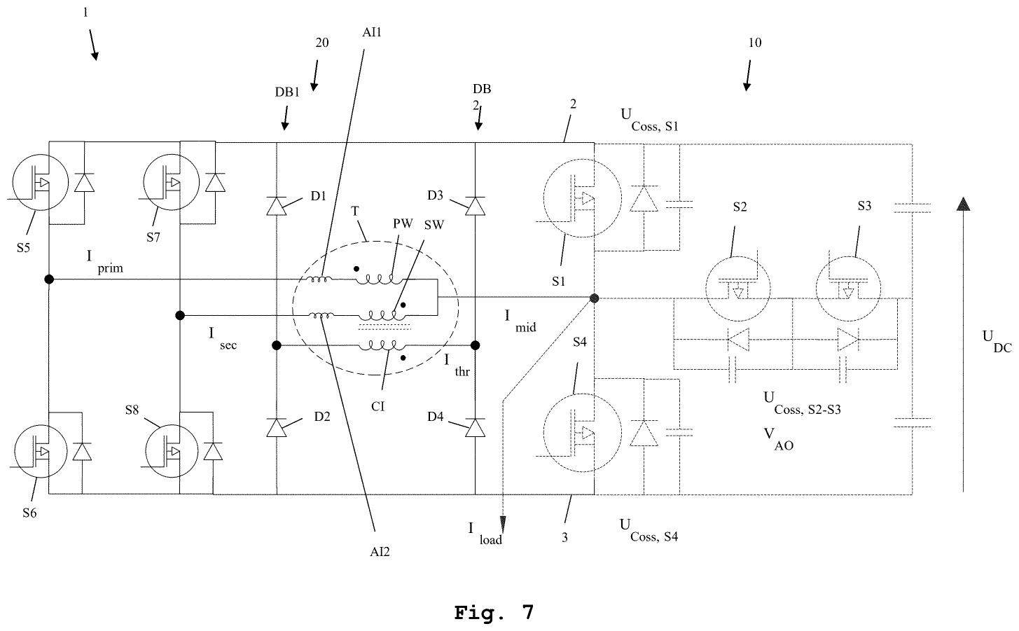

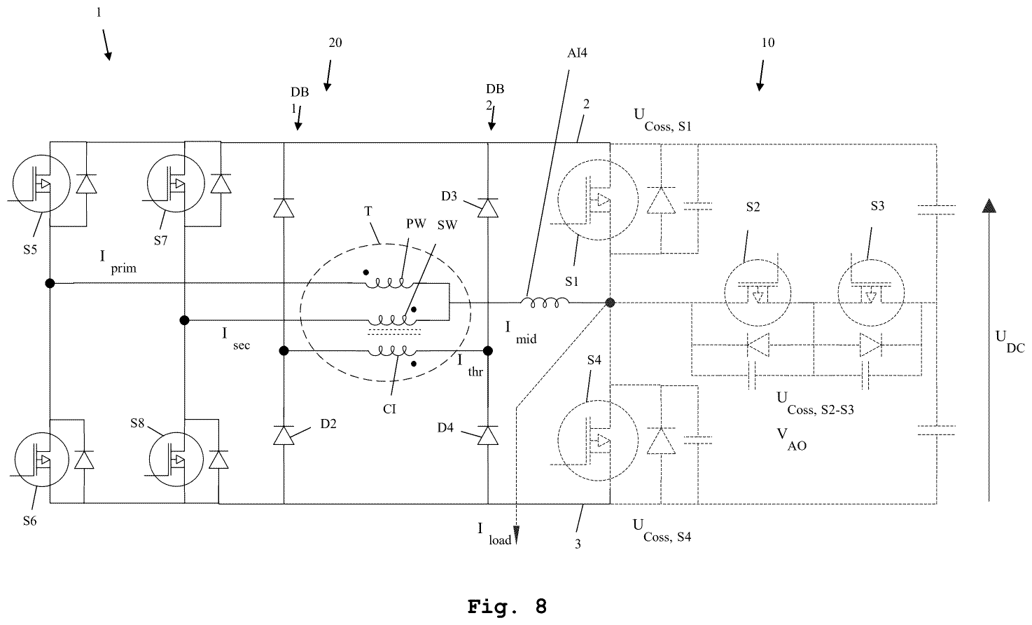

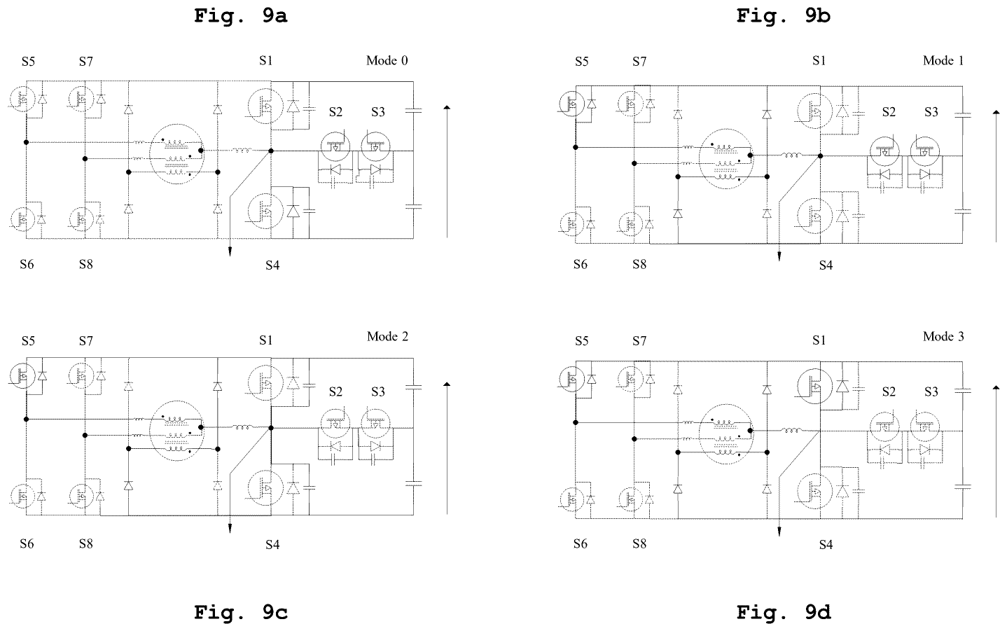

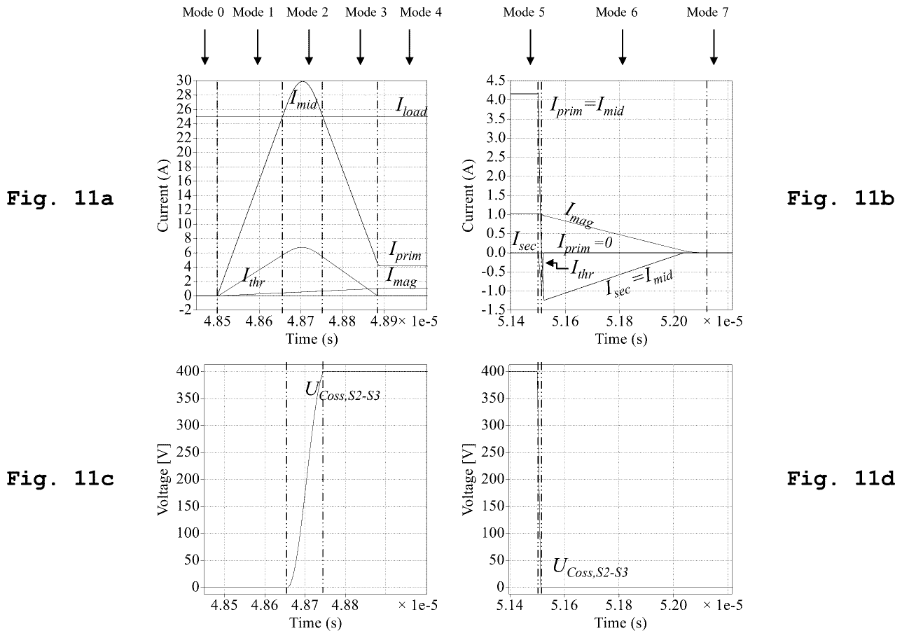

First, the general construction and function of an embodiment of the inverter is provided in FIG. 1. With respect to FIG. 2, an alternative construction is shown. In FIG. 3-FIG. 5d, details of the function of different embodiments of the inverter are described. In FIG. 6, the construction and function of an embodiment of the inverter system are shown in detail. With respect to FIG. 7 and FIG. 8, different embodiments of an alternative construction manner of the inverter are shown and described in detail. In FIGS. 9a-11d, details of the function in different operational states are shown.

Similar entities and reference numbers in different figures have been partially omitted.

In FIG. 1, a first embodiment of the inverter 1 is shown. The inverter 1 includes a positive voltage rail 2 and a negative voltage rail 3. The positive voltage rail 2 inputs a positive voltage of a direct current signal U_{DC}. The negative voltage rail 3 inputs the negative voltage of the direct current signal U_{DC}. Moreover, the inverter 1 includes a switching unit 10 connected to an auxiliary circuit 20. The switching unit 10 is displayed in dashed lines here. This merely indicates the differentiation between the switching unit 10 and the auxiliary circuit 20.

The switching unit 10 includes an alternating current output 12 and a plurality of switches S1, S2, S3, S4. Each of the switches S1-S4 includes a parasitic capacitance S1C, S2C, S3C, S4C, connected in parallel to the switch S1-S4. In addition, here diodes S1D, S2D, S3D, S4D, connected in parallel to the parasitic capacitances S1C-S4C are shown. These diodes S1D-S4D as well as the parasitic capacitances S1C-S4C are advantageously not present in the circuit as dedicated circuit elements, but are part of the switches S1-S4, and are only depicted to highlight their function.

Moreover, the switching unit 10 includes a first capacitor C_{DC1} connected between the positive voltage rail 2 and a mid-point 11, and a second capacitor C_{DC2} connected between the mid-point 11 and the negative voltage rail 3.

The switching unit 10 is configured to switch the alternating current output 12 between the positive voltage of the direct current signal U_{DC}, a mid-point voltage between the positive voltage and the negative voltage of the direct current signal U_{DC}, and the negative voltage of the direct current signal U_{DC}.

The auxiliary circuit 20 includes an asymmetrical transformer T, including a primary winding PW and a secondary winding SW. The primary winding PW and the secondary winding SW are magnetically coupled. In this embodiment, the transformer T additionally includes a first auxiliary inductor AI1 connected in series to the primary winding PW and a second auxiliary inductor AI2, connected in series to the secondary winding SW. Moreover, the auxiliary circuit 20 includes a number of switches S5, S6, S7, S8. A fifth switch S5 is connected between the positive voltage rail 2 and the primary winding PW. A sixth switch S6 is connected between the negative voltage rail 3 and the secondary winding SW. A seventh switch S7 is connected between the positive voltage rail 2 and the secondary winding SW. An eighth switch S8 is connected between the negative voltage rail 3 and primary winding PW. The switches S5-S8 are implemented as switching transistors here. In parallel to each of the switches S5-S8, a diode S5D, S6D, S7D, S8D is connected. The primary winding PW as well as the secondary winding SW connect the respective transistors to the alternating current output 12. In this embodiment, this connection is formed through the auxiliary inductors AI1, AI2. These auxiliary inductors AI1, AI2 are also not necessarily dedicated circuit elements, but can be the leakage inductance of the primary winding PW and the secondary winding SW. Alternatively, if the leakage inductances are too small, dedicated circuit elements can be used as auxiliary inductances AI1, AI2.

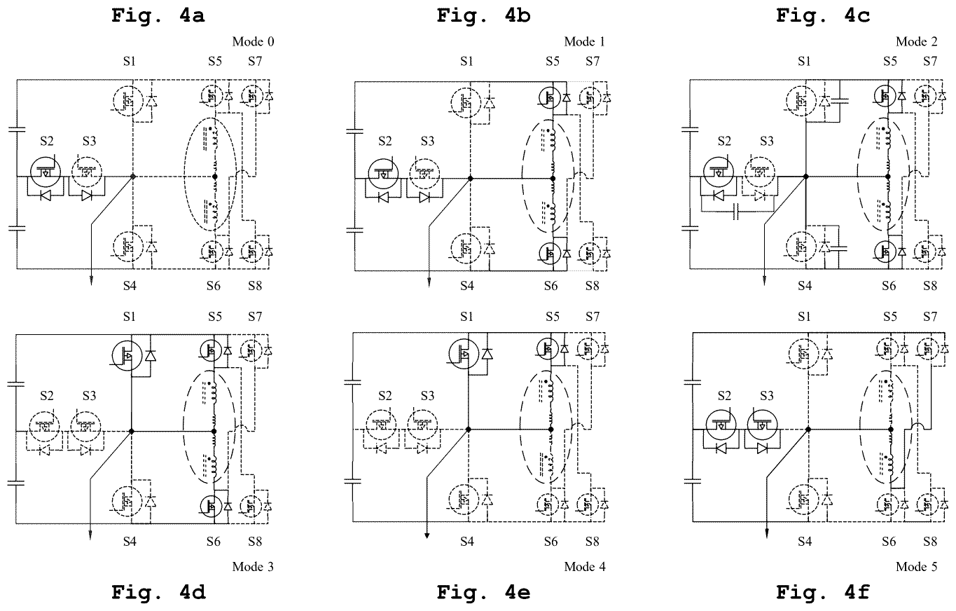

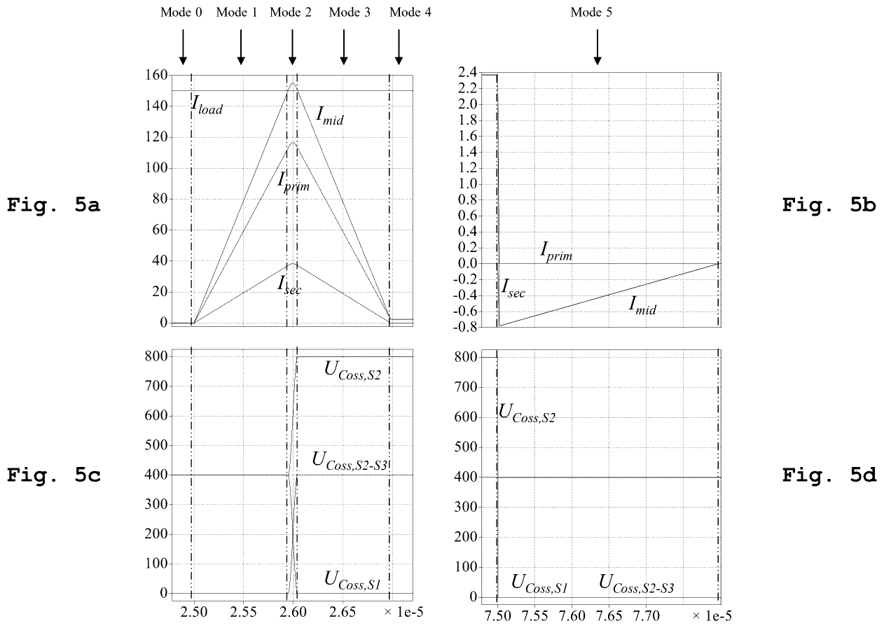

In operation, the inverter 1 inverts the direct current signal U_{DC} and generates an alternating current signal UAC. In order to do so, the switching unit 10 is configured to switch the alternating current output 12 between the positive voltage rail 2, the mid-point 11, and the negative voltage rail 3. Details of the sequence of the switching are shown in FIG. 4a-FIG. 5d.

The auxiliary circuit 20 therein is configured to provide currents to the alternating current output 12 to charge and discharge the parasitic capacitances S1C-S4C of the switches S1-S4 before at least some of the switching operations of the switching unit 10. Details of the function of the auxiliary circuit 20 are also explained in FIG. 4a-FIG. 5d.

The primary winding PW therein may have fewer windings than the secondary winding SW. For example, the primary winding has less than 1/2 of the turns of the secondary winding. In another example, the primary winding has 1/3 of the turns of the secondary winding.

Also, the leakage inductances of the auxiliary inductors AI1 and AI2 are not identical. Ideally, the leakage inductance of the auxiliary inductor AI1 is about nine times as large as the leakage inductance of the auxiliary inductor AI2. This ratio corresponds to the ratio of the primary winding having 1/3 of the turns of the secondary winding SW.

In FIG. 3, an equivalent circuit of the leakage inductances is shown.

For the transformer T, the most suitable turn ratio is ˜1/3. It is worth mentioning that other values of turns ratio can be adopted.

When the switches S5/S6 are active, the voltage in one of the terminals of the equivalent leakage inductor is 3/4U_{DC}. Similarly, when the switches S7/S8 are active, the voltage is 1/4U_{DC}. This allows to have a soft-turn-on transition for all transitions: S4↔>S2/S3 and S1↔>S2/S3.

In FIG. 2, a further embodiment of the inverter 1 is shown. The inverter 1 depicted here differs from the inverter of FIG. 1 in that the auxiliary inductances AI1 and AI2 are supplemented by a third auxiliary inductance AI3 connected between the auxiliary inductances AI1 and AI2, and the alternating current output 12. Apart from this change, the inverter 1 of FIG. 2 is identical to the inverter of FIG. 1.

If the leakage inductances of the transformer T, such as of the primary winding PW and the secondary winding SW are small or inexistent, an additional inductor AI3 can be placed in between the transformer T and the alternating current output 12. This alternative implementation is less advantageous as it requires one more component; however, it is a possible alternative.

The equivalent circuit of FIG. 3 is also relevant to the inverter 1 of FIG. 2.

In FIG. 4a-FIG. 4f, different operating modes of the inverter are shown. Here, only the reference signs regarding the switches S1-S8 are shown. The active parts of the circuit are shown with solid lines while the inactive parts of the circuit are shown with dashed lines. FIG. 5a-FIG. 5d show currents and voltages within the circuit in the different operating modes. For example, the load current I_{load}, the mid-point current I_{mid}, the current through primary winding Iₚᵣᵢₘ and the current through the secondary winding I_{sec} are shown. Also, the voltages across the first switch U_{Coss, S1} and the voltage across the fourth switch U_{Coss, S4}, and the voltages across the second and third switch U_{Coss, S2-S3} are shown.

In an operating mode 0, depicted in FIG. 4a, only the second switch S2 is active. All currents are zero, U_{Coss, S1-S3} is zero, while both U_{Coss, S2} and U_{Coss S1} are at a mid-point voltage between the negative voltage and the positive voltage.

Operating mode 1 is shown in FIG. 4b. S5 is turned on. This polarizes the diode S6D of S6. The current flows through S5 and S6, S6D in fact, towards the middle point 11. The current in S5 is three times higher than in S6, or rather S6D according to the turn ratio of 1:3. The rate of increase depends on the value of the leakage inductances AI1, AI2 of the transformer T. During operating mode 1, the mid-point current I_{mid}, the primary winding current Iₚᵣᵢₘ and the secondary winding current I_{sec} rise constantly while the depicted voltages remain constant.

The load current I_{load} is constant through all operating modes mode 0-mode 5.

Operating mode 2 is shown in FIG. 4c. Once the current at the alternating current output 12 is equal to the load current I_{load}, the resonance period starts. The leakage inductors AI1 and AI2 resonate with the capacitors S1C-S6C. As a result, the voltage in the capacitor S1C decays to zero, and S1 can be turned on under zero-voltage switching, ZVS, conditions. It can readily be seen that the mid-point current I_{mid}, the primary winding current Iₚᵣᵢₘ and the secondary winding current I_{sec} peak, in operating mode 2. The voltage across the second switch U_{Coss, S2} rises from zero to the positive voltage during mode 2, while the voltage across the first switch U_{Coss, S1} falls from the mid-point voltage to the negative voltage. The voltage across the switches S2, S3, U_{Coss, S2-S3} rises from zero to the mid-point voltage during operating mode 2.

Operating mode 3 is further depicted in FIG. 4d. When S1 is turned on, the voltage across the leakage inductance AI1 and AI2 reverses polarity. As a result, the current in the inductors decreases at a rate that is determined by the values of AI1 and AI2 and the DC-link value. This mode ends when the current in AI2 reaches zero. In this operating mode, the mid-point current I_{mid}, the primary winding current Iₚᵣᵢₘ, and the secondary winding current I_{sec} each constantly fall towards zero. The voltages all remain constant.

In FIG. 4c, the fourth operating mode 4 is shown. When the current in AI2 reaches zero, the only current left is the magnetizing current of the transformer T. As long as S5 is not turned off, this current will circulate through S1, S5, and AI1. When S5 is turned off, the magnetizing current will cease to flow in AI1. The Diode S7D of S7 will become forward-biased and the magnetizing current will therefore flow through S1, D7, and AI2. Since having current flowing in the body diode SID of S7 will result in higher losses, a better alternative is to keep S7 on during this mode. It can readily be seen that S1, S5, and S6 are active in this operating mode. In this operating mode, the mid-point current I_{mid}, the primary winding current Iₚᵣᵢₘ and the secondary winding current I_{sec} are zero or almost zero.

In FIG. 4f, an operating mode 5 is shown. One can readily see that now only the switches S1 and S5 are active. The mid-point current I_{mid}, the primary winding current Iₚᵣᵢₘ and the secondary winding current I_{sec} are zero or almost zero. Following the normal operation of the converter 1, after a certain time, the transition from S1 to S2 will take place. At this moment, S5 can be also turned off. The magnetizing current will polarize the diode S7D of S7, as explained above in Mode 4. As a result, the magnetizing current will therefore flow through S2, S3, AI2, and S7D. This produces a negative voltage across the magnetizing inductance which discharges linearly. At the end of Mode 5, the transformer T is reset, and a new transition can start. It can readily be seen that here, switches S2 and S3 are active. The primary winding current remains zero, while the secondary winding current and the mid-point current both rise constantly. The voltage across the first switch U_{Coss, S1}, and the voltage over the second and third switches U_{Coss. S2-S3} remain zero, while the voltage across the second switch U_{Coss, S2} remains at mid-point voltage.

In FIG. 6, an embodiment of the inverter system 100 is shown. The inverter system 100 includes a first inverter 1a, a second inverter 1b, and a third inverter 1c. All of the converters 1a-1c share a joint positive voltage rail 2 and a joint negative voltage rail 3. The first inverter 1a includes a switching circuit 10a, and an auxiliary circuit 20a, the second inverter 1b includes a switching circuit 10b, and an auxiliary circuit 20b, and the third inverter 1c includes a switching circuit 10c, and an auxiliary circuit 20c. The auxiliary circuits 20b, and 20c are not displayed in detail, but are constructed in the same manner as the auxiliary circuit 20a.

Each of the inverters 1a, 1b, and 1c has an alternating current output 12a, 12b, and 12c. The switches of the respective inverters 1a, 1b, and 1c are controlled so that the inverters 1a, 1b, and 1c each produce an alternating current signal, which is phase-shifted so that a three-phase alternating current signal is output at the alternating current output 12a, 12b, and 12c.

In FIG. 7, a further alternative construction of the inverter is shown. Here, the auxiliary circuit 20 includes a first diode bridge DB1 and a second diode bridge DB2, connected between the positive voltage rail 2 and the negative voltage rail 3. The first diode bridge DB1 includes a first diode D1 and a second diode D2 connected in series, forming a mid-point. The second diode bridge DB2 includes a third diode D3 and a fourth diode D4, forming a mid-point. The transformer T includes a primary winding PW and a secondary winding SW. In addition, here the transformer includes a further coupled inductance CI. This further coupled inductance CI is magnetically coupled to the primary winding and the secondary winding forming a third winding. Advantageously, it can include as many turns as the primary winding PW and the secondary winding SW together.

The further coupled inductance CI is connected between the mid-points of the diode bridges DB1 and DB2. Also, here, the auxiliary inductances AI1, AI2 are depicted. The function of this embodiment is referred to in the later descriptions regarding FIG. 9a-FIG. 11d.

In FIG. 8, a further alternative embodiment of the inverter 1 is shown. Again here, the auxiliary inductances AI1, AI2 are not large enough, so that a further fourth auxiliary inductance AI4 is added between the connection of the primary winding PW and the secondary winding SW, and the alternating current output 12.

Another way to implement the concept of asymmetric current sharing for soft-switching is implemented by the embodiments shown in FIG. 7 and FIG. 8. This alternative implementation may be less advantageous, as it requires more components and has higher losses due to the diode bridges DB1, DB2.

The state-mode transition and relevant waveforms are detailed in FIGS. 9a-11d. Here, the commutation from S2/S3 to S1 for a positive load current going out of the converter is shown.

Before the commutation starts, the load current is constant. The load current I_{load} is constant and flows through S2 and S3. This operating mode 0 is shown in FIG. 9a.

In FIG. 9b, an operating mode 1 is shown. S5 is turned on. This polarises the diodes S2D and S3D. The external inductor AI4 sees a voltage of around 3/4 U_{DC}. Due to this voltage, the current in this inductor increases. The same current flows through S1 and the primary winding PW. The current also flows through the diodes S2D and S3D, corrected by the turns-ratio of the primary winding PW and the coupled inductance CI. It is important to say that the magnetization inductance of the transformer T sees as voltage of U_{DC}, with respect to the winding of the coupled inductance CI. This produces a magnetizing current that needs to be discharged at some point to reset the transformer T. It can readily be seen that in this mode, only the switches S2, S3, and S5 are active. In FIG. 9c, operating mode 2 is shown. Once the current in the fourth auxiliary inductance AI4 equals the load current I_{load}, the resonance period starts. The auxiliary inductor AI4 resonates with the capacitors C_{OSS, S1}-S6. As a result, the voltage in C_{OSS, S1} decays to zero, and S1 can be turned on under zero voltage switching conditions. It can readily be seen here, that only S5 is active. In this mode, the mid-point current I_{mid} and the current in the further coupled inductance CI, Iₜₕᵣ peak. The magnetizing current I_{mag} slowly rises. The load current is constant through all operating modes. In this operating mode 2, the voltage across the switches S2, S3, U_{COOS, S2-S3} rises from zero to the positive voltage.

In FIG. 9d, operating mode 3 is shown. When S1 is turned on, the voltage across the auxiliary inductor 4 reverses polarity. The inductor sees a voltage of around −1/4 U_{DC}. This mode ends when the current in the coupled inductor CI reaches zero. It can readily be seen that here, the switches S1 and S5 are turned on. In this operating mode 3, the load current I_{load} is constant, while the mid-point current I_{mid} constantly falls. Also, the current in the further coupled inductor Iₜₕᵣ constantly falls, while the magnetizing current I_{mag} continues to rise. The voltage across the switches S2, S3, U_{COOS, S2-S3} remains constant at the positive voltage.

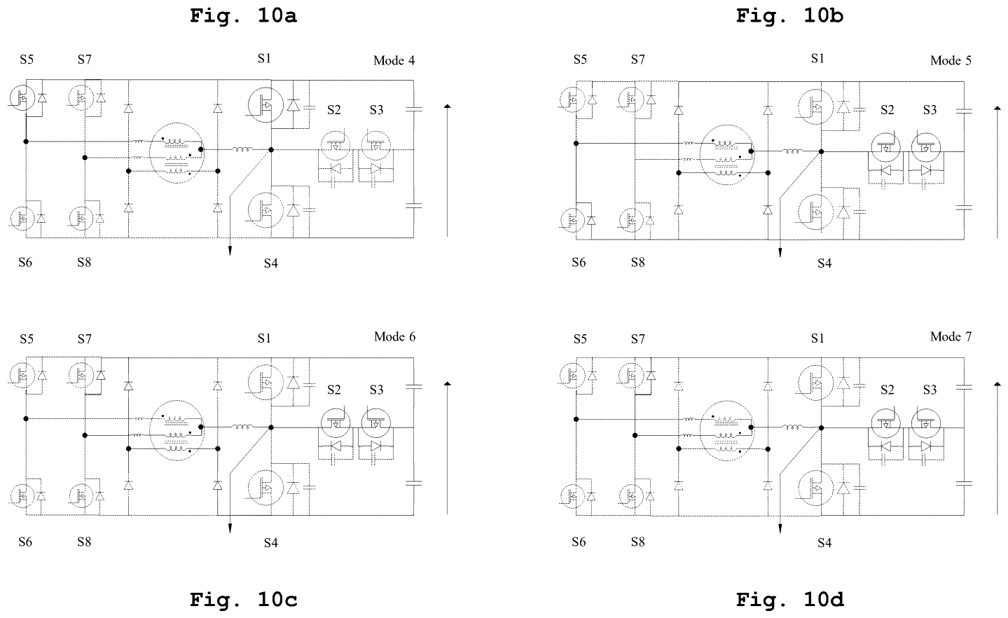

In FIG. 10a, an operating mode 4 is shown. At this point, the only current left is the magnetizing current I_{mag} of the transformer T. As long as S5 is not turned off, this current will circulate through S5, AI1, and AI4 indefinitely. This current is equal to the magnetizing current corrected by the turns-ratio. It can readily be seen here that only switches S1 and S5 are active. In this operating mode 4, the load current is constant, while the primary winding current Iₚᵣᵢₘ and the magnetizing current I_{mag} also remain constant. Moreover, the voltage across the switches S2, S3, U_{COOS, S2-S3} remains constant.

In FIG. 10b, an operating mode 5 is shown. Following the normal operation of the inverter 1, after a certain time, the transition from S1-S2/S3 will take place. At this moment, S5 can be also turned off. The diode S6D of S6 will conduct, leaving both AI4 and the magnetizing inductance with a negative voltage across. Consequently, the current in the auxiliary inductance AI4 and the magnetizing current decrease. This occurs, however, at different rates. The current in AI4 decreases faster than in the magnetizing inductance. The current in AI4, therefore, is no longer equal to the magnetizing current, corrected by the turns-ratio. The difference in current is carried by the diodes S1D and S4D, which become forward-biased during this transition. This mode ends when the current in AI4 reaches zero. It can readily be seen that here, only the switches S2 and S3 are active.

In FIG. 10c, an operating mode 6 is shown. The current in AI4 now decreases linearly and flows through AI2 and the diode S7D of S7. The diodes S1D and S4D continue to conduct part of the magnetizing current until the magnitude of the current through AI4 and AI2 is equal to the magnetizing current, corrected by the turns-ratio. If the secondary winding SW were not to exist, the magnetising current would flow through S1D and S4D until distinguished. However, in the presence of the secondary winding SW, the current is allowed to flow through AI4, AI2, and the diode S7D of S7. Operating mode 6 ends with the current in S1D and S4D reaching zero. It can readily be seen that in this operating mode, still only switches S2 and S3 are active. At the end of this operating mode, the magnetizing current I_{mag}, the primary current Iₚᵣᵢₘ, the secondary current I_{sec} and the mid-point current I_{mid} all are at zero.

Next, in FIG. 10d, an operating mode 7 is shown. When the current through AI4 and AI2 is equal to the magnetising current, corrected by the turns-ratio, the diodes S1D and S4D stop conducting. The magnetizing current keeps flowing through AI4 and AI2, but its magnitude keeps on decreasing until it reaches zero. At the end of operating mode 7, the transformer T is reset, and a new transition can start. It can readily be seen that in operating mode 7, still only the switches S2 and S3 are active.

The commutations shown in FIG. 4a-FIG. 5d and in FIG. 9a-FIG. 11d only cover one direction of commutation. The commutation in the other direction happens in the exact same manner but has been omitted here.

The embodiments are not limited to the specific inverter types or specific switch types. In addition to the here-depicted transistors, also other switches may be used. The characteristics of the exemplary embodiments can be used in any advantageous combination.

The embodiments have been described in conjunction with various examples and implementations herein. However, other variations to the embodiments can be understood and effected by those skilled in the art. In the embodiments, the words “comprising ”, “including”, “includes”, and the like do not exclude other elements or steps and the indefinite article “a” or “an” does not exclude a plurality. A single processor or other unit may fulfil the functions of several items recited in the embodiments. The mere fact that certain measures are recited in usually different embodiments does not indicate that a combination of these measures cannot be used to advantage. A computer program may be stored/distributed on a suitable medium, such as an optical storage medium or a solid-state medium supplied together with or as part of other hardware, but may also be distributed in other forms, such as via the internet or other wired or wireless communication systems.

1. An inverter for generating an alternating current signal from a direct current signal, the inverter comprising:
a positive voltage rail configured to input a positive voltage of the direct current signal,
a negative voltage rail configured to input a negative voltage of the direct current signal.
a switching unit comprising an alternating current output, and a plurality of switches, each of the plurality of switches comprising a parasitic capacitance, the switching unit being configured to output the alternating current signal,
wherein the switching unit is further configured to alternatingly switch the positive voltage of the direct current signal, a midpoint voltage between the positive voltage and the negative voltage of the direct current signal, and the negative voltage of the direct current signal to the alternating current output, and
an auxiliary circuit, configured to provide currents to the alternating current output to charge and discharge the parasitic capacitances of the switches before at least some switching operations of the switching unit,
wherein the auxiliary circuit comprises an asymmetrical transformer, the asymmetrical transformer comprising a primary winding and a secondary winding, wherein the primary winding and the secondary winding are magnetically coupled, and
wherein the asymmetrical transformer is configured to generate the current required to charge and discharge the parasitic capacitances of the switches.

2. The inverter according to claim 1,
wherein the auxiliary circuit (20)-is configured to generate a commutation voltage so as to enable zero-voltage-switching (ZVS) of switches of the switching unit.

3. The inverter according to claim 1,
wherein the switching unit further comprises:
a first capacitor connected between the positive voltage rail and a midpoint,
a second capacitor, connected between the negative voltage rail and the midpoint,
a first switching transistor, connected between the alternating current output und the positive voltage rail, configured to switch the alternating current output to the positive voltage,
either a bi-directional switch or a second switching transistor and a third switching transistor, connected in anti-series between the alternating current output and the midpoint, configured to switch the alternating current output to a midpoint voltage, and
a fourth switching transistor connected between the alternating current output and the negative voltage rai, configured to switch the alternating current output to the negative voltage.

4. The inverter according to claim 2,
wherein the switching unit further comprises:
a first capacitor connected between the positive voltage rail and a midpoint,
a second capacitor, connected between the negative voltage rail and the midpoint,
a first switching transistor, connected between the alternating current output und the positive voltage rail, configured to switch the alternating current output to the positive voltage,
either a bi-directional switch or a second switching transistor and a third switching transistor, connected in anti-series between the alternating current output and the midpoint, configured to switch the alternating current output to a midpoint voltage, and
a fourth switching transistor connected between the alternating current output and the negative voltage rail, configured to switch the alternating current output to the negative voltage.

5. The inverter according to claim 1,
wherein the primary winding and the secondary winding are directly connected to the alternating current output.

6. The inverter according to claim 2,
wherein the primary winding and the secondary winding are directly connected to the alternating current output.

7. The inverter according to claim 1,
wherein the primary winding is connected to the alternating current output through a first auxiliary inductor, and the first auxiliary inductor is a leakage inductance of the primary winding, and
wherein the secondary winding is connected to the alternating current output through a second auxiliary inductor and the second auxiliary inductor is a leakage inductance of the secondary winding.

8. The inverter according to claim 2,
wherein the primary winding is connected to the alternating current output through a first auxiliary inductor, and the first auxiliary inductor is a leakage inductance of the primary winding, and
wherein the secondary winding is connected to the alternating current output through a second auxiliary inductor, and the second auxiliary inductor is a leakage inductance of the secondary winding.

9. The inverter according to claim 1,
wherein the primary winding and the secondary winding are connected to the alternating current output through a third auxiliary inductor .

10. The inverter according to claim 2,
wherein the primary winding and the secondary winding are connected to the alternating current output through a third auxiliary inductor.

11. The inverter according to claim 1,
wherein the auxiliary circuit further comprises:
a fifth switching transistor connected between the positive voltage rail and the primary winding,
a sixth switching transistor connected between the negative voltage rail and the secondary winding,
a seventh switching transistor connected between the positive voltage rail and the secondary winding, and
an eighth switching transistor connected between the negative voltage rail and the primary winding.

12. The inverter according to claim 2,
wherein the auxiliary circuit further comprises:
a fifth switching transistor connected between the positive voltage rail and the primary winding,
a sixth switching transistor connected between the negative voltage rail and the secondary winding,
a seventh switching transistor connected between the positive voltage rail and the secondary winding, and
an eighth switching transistor connected between the negative voltage rail and the primary winding .

13. The inverter according to claim 1,
wherein the primary winding has fewer turns than the secondary winding.

14. The inverter according to claim 2,
wherein the primary winding has fewer turns than the secondary winding.

15. The inverter according to claim 1,
wherein the auxiliary circuit is configured to charge and/or discharge the parasitic capacitances of the switches before all switching operations of the switching unit.

16. The inverter according to claim 2,
wherein the auxiliary circuit is configured to charge and/or discharge the parasitic capacitances of the switches before all switching operations of the switching unit.

17. The inverter according to claim 1,
wherein the auxiliary circuit is configured to charge and/or discharge the parasitic capacitances of the switches only before switching operations of the switching unit, when the inverter is operating at a power level below a threshold value, the threshold value being within 30%-90% of a maximum power level of the inverter.

18. The inverter according to claim 1, further comprising
a first diode bridge, comprising a series connection of a first diode and a second diode, connected between the positive voltage rail and the negative voltage rail, the first diode bridge comprising a midpoint between the first diode and the second diode,
a second diode bridge, comprising a series connection of a third diode and a fourth diode, connected between the positive voltage rail and the negative voltage rail, the second diode bridge comprising a midpoint between the third diode and the fourth diode, and
a further coupled inductance, inductively coupled to the primary winding and the secondary winding of the transformer, operating as a third winding,
wherein midpoints of the diode bridges are connected to each other through the further coupled inductance.

19. The inverter according to claim 18,
wherein the further coupled inductance has as many turns as a sum of the turns of the primary winding and the secondary winding.

20. The inverter according to claim 18, further comprising
a fourth auxiliary inductor, coupled between the alternating current output and a connection of the primary winding and the secondary winding.
